(19) United States
(12) Patent Application Publication
(10) Pub. No.: US 2012/0031550 A1
(43) Pub. Date: Feb. 9, 2012

(54) Method for forming a plating layer and method for manufacturing a circuit board using the same

(75) Inventors: Jeong-Ho Moon, Suwon-si (KR); Kwang-Ok Jeong, Gwangmyeong-si (KR); Won-Gyu Park, Cheongju-si (KR); Hyo-Seung Nam, Hwaseong-si (KR)

(73) Assignee: SAMSUNG ELECTRO-MECHANICS CO., LTD., Suwon (KR)

(21) Appl. No.: 13/137,241

(22) Filed: Jul. 29, 2011

(30) Foreign Application Priority Data
Aug. 3, 2010 (KR) 10-2010-0075011

(51) Int. Cl. B32B 37/02; B32B 38/10; B32B 37/14; B05D 5/12; C25D 5/02

(52) U.S. Cl. 156/236; 427/97.3; 205/125

(57) ABSTRACT

A method for forming a plating layer and a method for forming a printed circuit board using the same are disclosed. The method for forming a plating layer in accordance with an embodiment of the present invention can include: providing a metal foil coated with a primer resin layer on one surface thereof, roughness formed the one surface of the primer resin layer; transcribing the primer resin layer, on which roughness is formed, to an insulation layer; reducing the primer resin layer so that an anticorrosive material of the metal foil that remains on the primer resin layer is removed; and plating the primer resin layer, on which roughness is formed.

### CROSS-REFERENCE TO RELATED APPLICATIONS

This application claims the benefit of Korean Patent Application No. 10-2010-0075011, filed with the Korean Intellectual Property Office on Aug. 3, 2010, the disclosure of which is incorporated herein by reference in its entirety.

### BACKGROUND

1. Technical Field

The present invention is related to a method for forming a plating layer and a method for manufacturing a circuit board using the method of forming a plating layer.

2. Background Art

The semi additive process (SAP) has received much attention for a method for manufacturing a circuit board having a fine circuit.

Generally, in the SAP, a plating layer that is formed by electroless plating is used, and a primer resin is used for adhesion of the plating layer.

However, an anticorrosive material for preventing the corrosion of copper foil may remain in the primer resin during the manufacturing process, causing a problem in forming the plating layer.

### SUMMARY

The present invention provides a method for forming a plating layer that forms a uniform plating layer and a method for manufacturing a printed circuit board using the method for forming a plating layer.

An aspect of the present invention features a method for forming a plating layer. The method for forming a plating layer in accordance with an embodiment of the present invention can include: providing a metal foil coated with a primer resin layer on one surface thereof, roughness formed the one surface of the primer resin layer; transcribing the primer resin layer, on which roughness is formed, to an insulation layer; reducing the primer resin layer so that an anticorrosive material of the metal foil that remains on the primer resin layer is removed; and plating the primer resin layer, on which roughness is formed.

The reducing of the primer resin layer can include dipping the primer resin layer in a reductive solution containing a reductive material.

The transcribing of the primer resin layer can include: stacking the metal foil on the insulation layer so that the primer resin layer is adhered to the insulation layer; and removing the metal foil by etching.

The plating of the primer resin layer can include: adsorbing palladium in the primer resin layer; and electroless plating the primer resin layer.

Another aspect of the present invention features a method for forming a printed circuit board. The method for forming a printed circuit board in accordance with an embodiment of the present invention can include: providing a metal foil coated with a primer resin layer on one surface thereof, roughness formed the one surface of the primer resin layer; transcribing the primer resin layer, on which roughness is formed, to an insulation layer; reducing the primer resin layer so that an anticorrosive material of the metal foil that remains on the primer resin layer is removed; and forming a circuit pattern on the primer resin layer, on which roughness is formed.

The reducing of the primer resin layer can include dipping the primer resin layer in a reductive solution containing a reductive material.

The transcribing of the primer resin layer can include: stacking the metal foil on the insulation layer so that the primer resin layer is adhered to the insulation layer; and removing the metal foil by etching.

The forming of the circuit pattern can include: forming a seed layer on the primer resin layer; and forming the circuit pattern by performing electroplating by using the seed layer as an electrode.

The forming of the seed layer can include: adsorbing palladium in the primer resin layer; and forming the seed layer by electroless plating.

### BRIEF DESCRIPTION OF THE DRAWINGS

FIG. 1 is a flow diagram showing a method for manufacturing a printed circuit board in accordance with an embodiment of the present invention.

FIGS. 2 to 11 illustrate the method for manufacturing a printed circuit board in accordance with an embodiment of the present invention.

### DETAILED DESCRIPTION

Hereinafter, an embodiment of the present invention will be described in detail with reference to the accompanying drawings.

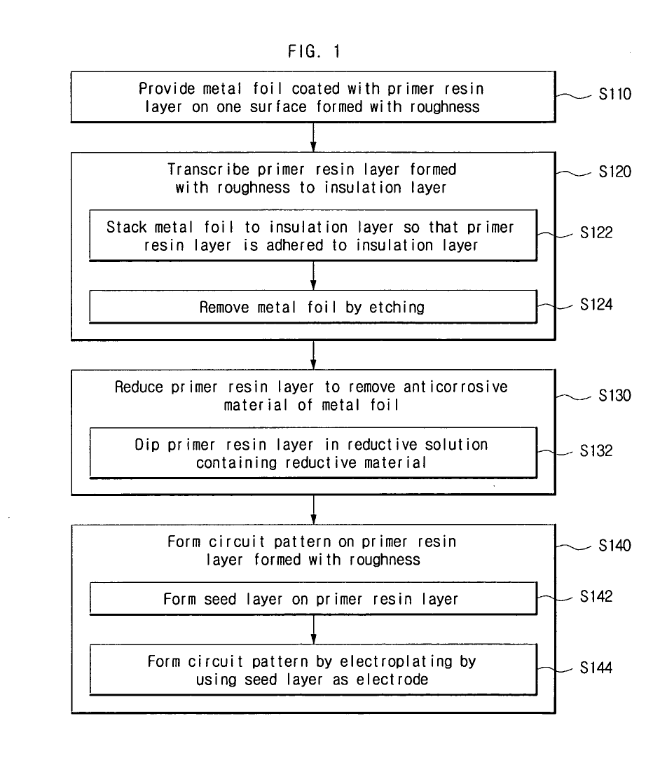

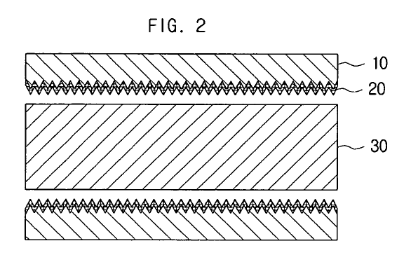

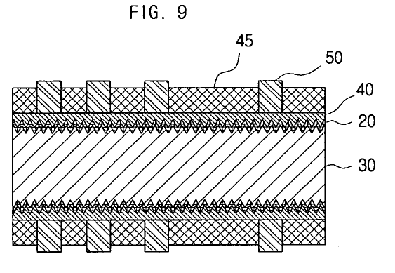

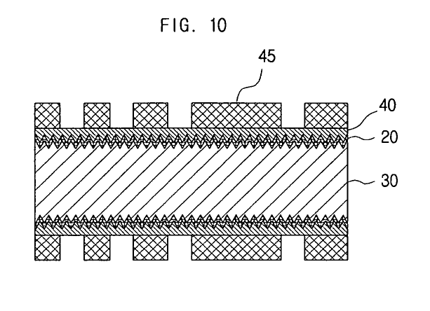

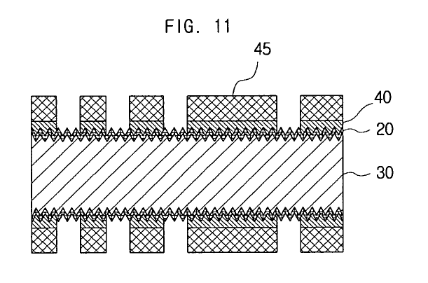

FIG. 1 is a flow diagram showing a method for manufacturing a printed circuit board in accordance with an embodiment of the present invention, and FIGS. 2 to 11 illustrate the method for manufacturing a printed circuit board in accordance with an embodiment of the present invention.

The method for manufacturing a printed circuit board in accordance with an embodiment of the present invention includes providing a metal foil (S110), transcribing a primer resin layer (S120), reducing (S130) and forming a circuit pattern (S140).

In the step of providing a metal foil (S110), a metal foil 10 having a primer resin layer 20 coated on one surface thereof, on which roughness is formed, is provided. That is, by using the roughness of the metal foil 10, roughness is formed on the primer resin layer 20. Here, primer resin is a highly adhesive material that can enhance the adhesion between a circuit pattern 45 and an insulation layer 30.

As illustrated in FIG. 2, in the present embodiment, the primer resin layer 20 having roughness formed thereon is formed by spraying the primer resin or stacking the primer resin in the form of film on one surface of the metal foil 10, on which roughness is formed.

In the step of transcribing the primer resin layer (S120), the primer resin layer 20 on which roughness is formed is transcribed to the insulation layer 30. In other words, in the present embodiment, the primer resin layer 20 on which roughness is formed is used as an adhesive layer for enhancing the adhesion of the insulation layer 30.

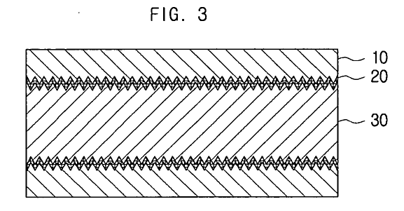

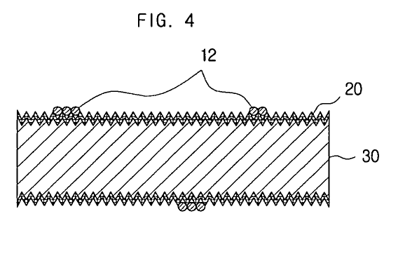

As illustrated in FIGS. 3 and 4, in the present embodiment, the metal foil 10 coated with the primer resin layer 20 is stacked on the insulation layer 30 (S112), and the primer resin layer 20 is adhered to the insulation layer 30. Then, by etching off the metal foil 10 (S114), the primer resin layer 20 on which roughness is formed is formed on the insulation layer 30.

The method of removing the metal foil 10 is not restricted to what is described in the present embodiment, and it shall be appreciated that the metal foil 10 can be removed by various known methods, such as peeling.

In the step of reducing (S130), the primer resin layer 20 is reduced so that an anticorrosive material 12 of the metal foil 10 that remains on the primer resin layer 20 is removed.

In general, the metal foil 10 is treated with the anticorrosive material 12 that is made of silicon (Si), chrome (Cr) or nickel (Ni) for the purpose of preventing corrosion. Accordingly, as illustrated in FIG. 4, it is possible that the anticorrosive material 12 remains on the primer resin layer 20 that is separated from the metal foil 10. Since it is difficult to plate an area where the anticorrosive material 12 remains, the anticorrosive material 12 inhibits a plating layer that is required for forming the circuit pattern 45 from forming.

Therefore, in the present embodiment, a reduction process is performed prior to forming the circuit pattern 45 in order to remove the anticorrosive material 12 remaining on the primer resin layer 20. That is, by reducing and ionizing the anticorrosive material 12, the anticorrosive material 12 can be readily removed from the primer resin layer 20. For example, chromium oxide, which is an anticorrosive material 12, can be reduced with chrome ion and then removed.

Particularly, in the present embodiment, the primer resin layer 20 is dipped in a reductive solution 6, which contains a reductive material, so that the roughness formed on the primer resin layer 20 is not damaged during the reductive process (S132).

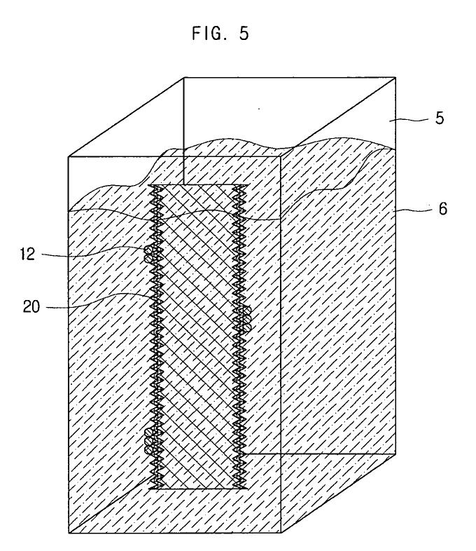

As illustrated in FIG. 5, in the present embodiment, the reductive process is performed by vertically dipping a substrate formed with the primer resin layer 20 in a tank 5 filled with the reductive solution 6. In the reductive solution 6, the anticorrosive material 12 is ionized and comes out to the reductive solution 6.

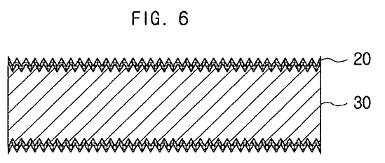

Accordingly, as illustrated in FIG. 6, the anticorrosive material 12 can be removed without causing any damage on the roughness of the primer resin layer 20.

The method of reductive process is not restricted to what is described in the present embodiment, and it shall be appreciated that the reductive process can be performed in various ways, such as spaying the reductive solution 6.

In the step of forming the circuit pattern (S140), the circuit pattern 45 is formed on the primer resin layer 20 on which roughness is formed.

Particularly, in the present embodiment, a uniform plating layer is formed by plating on the primer resin layer 20 from which the anticorrosive material 12 is removed, and the plating layer can be used as a seed layer 40 that is required for forming the circuit pattern 45. Then, the circuit pattern 45 can be formed by electroplating the plating layer by using the seed layer 40 as an electrode.

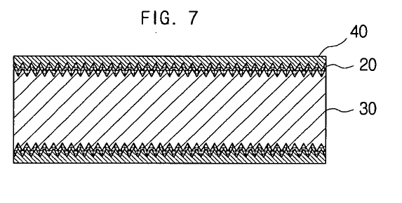

As illustrated in FIG. 7, in the present embodiment, the seed layer 40 is formed by plating the reduced primer resin layer 20.

Specifically, the seed layer 40 can be formed by electroless plating after adsorbing palladium in the primer resin layer 20. Here, since the anticorrosive material 12 has been removed from the primer resin layer 20, the seed layer 40 can be uniformly formed by uniformly adsorbing palladium in the primer resin layer 20.

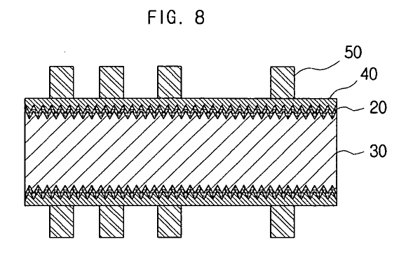

Then, as illustrated in FIGS. 8 to 11, the fine circuit pattern 45 can be formed by use of the semi additive process (SAP). As described above, since the insulation layer 30 to which the primer resin layer 20 formed with roughness is adhered has an enhanced adhesiveness, peeling of the circuit pattern 45 can be prevented even though the fine circuit pattern 45 is formed.

Specifically, after selectively stacking plating resist 50 on the seed layer 40, the circuit pattern 45 is formed by performing electroplating where the plating resist 50 is not stacked. Then, after the plating resist 50 is removed, each circuit pattern 45 is separated by removing the seed layer 40 by flash etching.

Although some embodiment of the present invention has been described above, it shall be appreciated that there can be a variety of permutations and modifications of the present invention by those who are ordinarily skilled in the art to which the present invention pertains without departing from the technical ideas and scope of the present invention, which shall be defined by the appended claims.

It shall be also appreciated that many embodiments other than the embodiment described above are present in the claims of the present invention.

What is claimed is:

1. A method for forming a plating layer, the method comprising:
providing a metal foil coated with a primer resin layer on one surface thereof, roughness formed the one surface of the primer resin layer;
transcribing the primer resin layer, on which roughness is formed, to an insulation layer;
reducing the primer resin layer so that an anticorrosive material of the metal foil that remains on the primer resin layer is removed; and
plating the primer resin layer, on which roughness is formed.

2. The method of claim 1, wherein the reducing of the primer resin layer comprises dipping the primer resin layer in a reductive solution containing a reductive material.

3. The method of claim 1, wherein the transcribing of the primer resin layer comprises:
stacking the metal foil on the insulation layer so that the primer resin layer is adhered to the insulation layer; and
removing the metal foil by etching.

4. The method of claim 1, wherein the plating of the primer resin layer comprises:
adsorbing palladium in the primer resin layer; and
electroless plating the primer resin layer.

5. A method for forming a printed circuit board, the method comprising:
providing a metal foil coated with a primer resin layer on one surface thereof, roughness formed the one surface of the primer resin layer;
transcribing the primer resin layer, on which roughness is formed, to an insulation layer;
reducing the primer resin layer so that an anticorrosive material of the metal foil that remains on the primer resin layer is removed; and
forming a circuit pattern on the primer resin layer, on which roughness is formed.

6. The method of claim 5, wherein the reducing of the primer resin layer comprises dipping the primer resin layer in a reductive solution containing a reductive material.

7. The method of claim 5, wherein the transcribing of the primer resin layer comprises:
stacking the metal foil on the insulation layer so that the primer resin layer is adhered to the insulation layer; and
removing the metal foil by etching.

8. The method of claim 5, wherein the forming of the circuit pattern comprises:
forming a seed layer on the primer resin layer; and
forming the circuit pattern by performing electroplating by using the seed layer as an electrode.

9. The method of claim 8, wherein the forming of the seed layer comprises:
adsorbing palladium in the primer resin layer; and
forming the seed layer by electroless plating.
